(19) United States
(12) Patent Application Publication
(10) Pub. No.: US 2024/0295294 A1
(43) Pub. Date: Sep. 5, 2024

(54) Lighting Device And Set Of Lighting Devices

(71) Applicant: Daniel Garcia van de Groote Poort, Kerpen (DE)

(72) Inventor: Daniel Garcia van de Groote Poort, Kerpen (DE)

(73) Assignee: ROXX GmbH, Köln (DE)

(21) Appl. No.: 18/418,874

(22) Filed: Jan. 22, 2024

(30) Foreign Application Priority Data
Feb. 9, 2023 (DE) 10 2023 103 124.4

(51) Int. Cl. F21S 2/00; F21V 15/01; F21V 21/005; F21Y 105/10; F21Y 113/13; F21Y 115/10

(52) U.S. Cl. CPC F21S 2/005; F21V 15/01; F21V 21/005; F21Y 2105/10; F21Y 2113/13; F21Y 2115/10

(57) ABSTRACT

A lighting device with a plurality of first lighting elements (20) adapted to emit light in a fixed first light spectrum and a plurality of second lighting elements (30) adapted to emit light in a variable light spectrum, wherein the first lighting elements (20) and the second lighting elements (30) are each arranged in at least two rows of first lighting elements (20-1, 20-2, 20-3, 20-4, 20-5, 20-6, 20-7, 20-8, 20-9) and at least two rows of second lighting elements (30-1, 30-2, 30-3, 30-4, 30-5, 30-6, 30-7, 30-8, 30-9, 30-10), wherein at least a part of the rows of first lighting elements (20-1, 20-2, 20-8, 20-9) is arranged as a single row.

### BACKGROUND OF THE INVENTION

### 1. Field of the Invention

The invention relates to a lighting device, such as used in particular in event lighting technology, and a set of such lighting devices, which can be grouped into a cluster by a connection system. In particular, the invention relates to a lighting device, which can achieve stroboscope-like lighting effects.

### 2. Description of the Related Art

For the illumination of events, such as theatres, stage shows or other events, professional lighting technology is often used to create a lighting composition for the room to be illuminated, often in accordance with a stage show changing and matching to the stage show. For this purpose, various lighting components are arranged at suitable points in the room and correspondingly controlled as required. Used lighting components are for example spotlights, floodlights, blinders, strobes, area lights and the like, also in various combinations.

By means of the arrangement of several, possibly different lighting effects, on the one hand the room can be illuminated in desired color tones and brightness, also variable in time, and on the other hand targeted, e.g. short-term, light effects can be set. Thus, at suitable times, in addition to the light composition appearing, for example, in darker colors, targeted dazzling/glare effects can be set by means of one or more blinders and/or bright and fast flashes can be generated by means of stroboscopes, and thus the attention of the audience can be directed by the lighting effects to a particular scene or a partial area of the room, etc.

In particular, stroboscopes with a central flash tube are often used for this purpose. A stroboscope emits light flashes at specific, often regular intervals. The flash duration is less than 5 ms, the frequency of the flashes is for example between 0.5 and 100 Hz. Such stroboscope-like lighting devices, traditionally provided by means of Xenon flash lamps, are also imitated by the use of LEDs (light-emitting diodes), in that the LEDs emit white light.

It is further known to combine stroboscope lighting devices with colored lighting means. An example of a lighting device that can be varied in a light spectrum and thus can be used for colored stage illumination and as a stroboscope at the same time is described in DE 2020 170 050 50 U1. However, the lighting device described there cannot be used flexibly, in particular for creating large-area lighting patterns or images.

### SUMMARY OF THE INVENTION

It is an object of the invention to provide a lighting device which is suitable for providing large area lighting patterns or lighting images by combination with other lighting devices and which can also be used for stroboscopic effects as required.

### DISCLOSURE OF THE INVENTION

This object is solved with a lighting device comprising the features of claim 1 and a set of lighting devices comprising the features of claim 15. Preferred embodiments are given in the dependent claims.

The invention is based on the idea of providing a lighting device, which can be used on the one hand for stroboscope effects for e.g. stage lighting and on the other hand also for colored lighting effects, wherein the lighting device is designed for both stroboscope effects and color lighting in such a way that different lighting patterns can be generated both in the context of the individual lighting device and by combination of several lighting devices to a set. In particular, the lighting device is based on the idea that those lighting elements which generate stroboscope effects are not only provided as a strip in a central area of the lighting device as in the case of a classical stroboscope, but rather are arranged in a special distribution on the surface of the lighting device.

For this purpose, the lighting device comprises a plurality of first lighting elements adapted to emit light in a fixed first light spectrum and a plurality of second lighting elements adapted to emit light in a variable light spectrum, wherein the first lighting elements and the second lighting elements are arranged in at least two rows of first lighting elements and at least two rows of second lighting elements, respectively, wherein at least a part of the rows of first lighting elements is arranged as a single row.

In such a lighting device, the lighting elements are generally arranged in rows on a substantially two-dimensional surface at regular intervals from one another at least in one direction of the surface. That is, both the first and second lighting elements are arranged in respective rows of first lighting elements and rows of second lighting elements. In the direction perpendicular to these rows, the lighting components may also be arranged at the same distances as the lighting elements of a single row from each other, or larger distances may be provided between adjacent rows. Within a row, either first lighting elements or second lighting elements are provided and the lighting elements are not mixed. By this arrangement of the first and the second lighting elements, in addition to at least two line-shaped or strip-shaped stroboscope-like light effects, a colored illumination can also be generated by means of the second lighting elements, to which no fixed light spectrum is assigned.

That the first lighting elements are arranged in a single row of first lighting elements means that the arrangement is interrupted in the direction perpendicular to the direction of the row by rows of second lighting elements and/or that two rows of first lighting elements are spaced apart from each other to such an extent that when lighted the row appears as a single line and does not merge with an adjacent row. For example, the distance between two rows is chosen to be greater than the distance between two lighting elements of a row, or a row is omitted. On the other hand, in addition to the row or rows of first lighting elements arranged as a single row, a block of multiple rows of first lighting elements may be formed to achieve the effect of a wider strip of illumination.

The first and second lighting elements may all be arranged on a common panel, or a plurality of panels may be provided, each carrying first lighting elements or second lighting elements or combinations of first and second lighting elements.

Providing at least four rows of lighting elements, namely at least two rows of first lighting elements and two rows of second lighting elements, results in a high flexibility for achieving different lighting effects, i.e. any combination of lighting elements can be controlled simultaneously or sequentially and thus different light patterns can be achieved.

According to a preferred embodiment, the fixed first light spectrum of the first lighting component is white, preferably cold-white. This serves to achieve a stroboscope effect by means of the first lighting elements. If several rows of first lighting elements with a white light spectrum are provided immediately adjacent to each other in an area of the lighting device, when they are driven together for illumination, they achieve a striped or tubular effect that can be perceived as a stroboscope effect if the duration of operation is short enough, e.g. below 5 ms, so that the lighting up in white or cold-white is perceived as a white flash. By using white lighting elements, the energy density required for stroboscopic effects can be achieved (in contrast to lighting elements that are variable in their spectrum, which can also produce white light, among other things). Furthermore, the classic stroboscope effect is achieved with white light.

Preferably, the variable light spectrum of the second lighting elements is an RGB light spectrum. Further preferably, the lighting elements can be varied in the emitted color, i.e. the emitted light, depending on their control, and thus various lighting effects can be achieved.

According to a preferred embodiment, the first and second lighting elements are each LEDs. This allows the arrangement of all lighting elements on a common panel, if desired. In addition, the use of LEDs makes sense from a thermal point of view and with regard to energy consumption, since they emit little heat at relatively high light energy and low power consumption.

Preferably, the rows of first lighting elements arranged as a single row are each covered with an elliptical lens. This imitates the appearance of the illumination of conventional, traditional Xenon bulbs.

Preferably, at least three rows of first lighting components are provided, and a portion of the rows of first lighting elements is grouped into a group of first lighting elements having at least two immediately adjacent rows of first lighting components. For example, if three rows of first lighting elements are provided, a group of two rows of first lighting elements is provided in addition to the one row of first lighting elements arranged as a single row. Such grouped rows of first lighting elements can be provided in a particularly preferred manner as a single unit, controllable together, e.g. by being arranged on a single, common carrier.

Preferably, several individual rows of first lighting elements are provided. In particular, if these individual rows are arranged symmetrically to an axis of symmetry of the lighting device extending in the direction of the rows, have equal distances to each other, and further, in particular to the edge of the lighting device, the outermost of the individual rows each have half of this distance, a variety of patterns, symbols, graphics, etc. can be displayed by combinations of several lighting devices and controls of the rows of first lighting elements or of partial areas of these rows.

Further preferably, this group of rows of first lighting elements or one of the groups of rows of first lighting elements is arranged in a central area of the lighting device, in a direction perpendicular to the rows. Thus, a stroboscopic effect can be achieved particularly well with the central group of rows of first lighting elements when driven together, since these lighting elements merge into a strip. If this group is provided centrally on the lighting device, a combination of several lighting devices next to each other in the direction of the rows can imitate a continuous stroboscope line over several lighting devices, which also merge into an overall structure. By combining several lighting devices side by side in the direction perpendicular to the rows, the central position of the group on each of the illumination devices can, for example, create a uniform stripe pattern.

In a particularly preferred example, a central group of five rows of first lighting elements is provided. These rows of the central group of first lighting elements can be provided in a particularly preferred manner on a single, common LED carrier and jointly controllable. Such a grouping of several rows of first lighting elements has the advantage and the effect that a relatively high output power can be achieved on a very compact area. Thus, a high luminosity and brightness can be achieved. Adjacent to this group in the direction perpendicular to the rows, a single row of first lighting elements, a group of five rows of second lighting elements and a further single row of first lighting elements are provided on each side, axisymmetric to an axis of symmetry extending along the central row. This means that a large number of patterns, graphics, etc. can be produced both with a single lighting device and with a combination of several lighting devices.

If rows of first lighting elements are arranged as a group, they are preferably covered with a common elliptical lens so that the effect of a Xenon tube is achieved and imitated.

Preferably, the lighting elements of the group of first lighting elements and/or the lighting elements of the individual rows of first lighting elements are grouped in the direction along the longitudinal direction of the rows into several segments that can be controlled separately from each other. It is particularly preferred if at least the individual rows of first lighting elements are provided as in several separately controllable segments, e.g. 12 segments. For example, 6 or 12 separately controllable segments can be provided along a row. This further increases flexibility and the ability to display a variety of patterns, shapes and graphics.

Preferably, at least some of the rows of second lighting elements are grouped into a group of second lighting elements with at least two directly adjacent rows of second lighting elements. Thus, different color patterns can be achieved.

Preferably, the lighting elements of the group of second lighting elements are grouped in the direction along the longitudinal direction of the rows into several separately controllable segments. For example, 6 or 12 separately controllable segments can be provided along a row. This further increases flexibility and the ability to display a variety of patterns, shapes and graphics.

Preferably, the lighting device further comprises a controller device for controlling the lighting elements or the groups or segments of lighting elements.

According to a preferred embodiment, the lighting device further comprises a substantially cuboid housing, wherein the lighting elements are arranged on a substantially two dimensional, preferably rectangular surface of the cuboid housing. This facilitates and increases the possibilities for combinations with additional lighting devices.

However, it is often desirable, for practical or aesthetic reasons or for creating large-scale lighting patterns or lighting images to arrange several identical or different lighting components together so that they form a unit. Especially, when the lighting components are used for mobile applications, it is advantageous if they can be flexibly grouped and separated again as required, depending on the intended purpose. Thus, preferably a set of lighting devices as described in the foregoing is provided, the set comprising a first lighting device with a first connecting surface and a second lighting device with a second connecting surface, wherein at the first connecting surface of the first lighting device a first connecting member of a connecting mechanism is provided and at the second connecting surface of the second lighting device a second connecting member of a connecting mechanism is provided, which is complementary to the first connecting member, such that the first lighting device can be detachably connected to the second lighting device by detachably connecting the first connecting member to the second connecting member. A suitable connecting mechanism is disclosed, e.g., in DE 10 2022 117 390, which is incorporated by reference.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, the invention is described by way of example with reference to the attached figures, in which:

FIG. 1 is a front view showing an embodiment of a lighting device without elliptical lenses;

FIG. 2 shows a front view of the lighting device of FIG. 1 with elliptical lenses;

FIG. 3 shows a perspective view of the lighting device of FIG. 1;

FIG. 4 shows a top view of the lighting device of FIG. 1;

FIG. 5 shows an example of a graphic obtainable with a set of two lighting devices as shown in FIG. 1;

FIG. 6 shows another example of a graphic obtainable with a set of two lighting devices according to FIG. 1; and

FIG. 7 shows an example of a strobe graphic obtainable with a set of two lighting devices according to FIG. 1.

### DETAILED DESCRIPTION OF THE PRESENTLY PREFERRED EMBODIMENTS

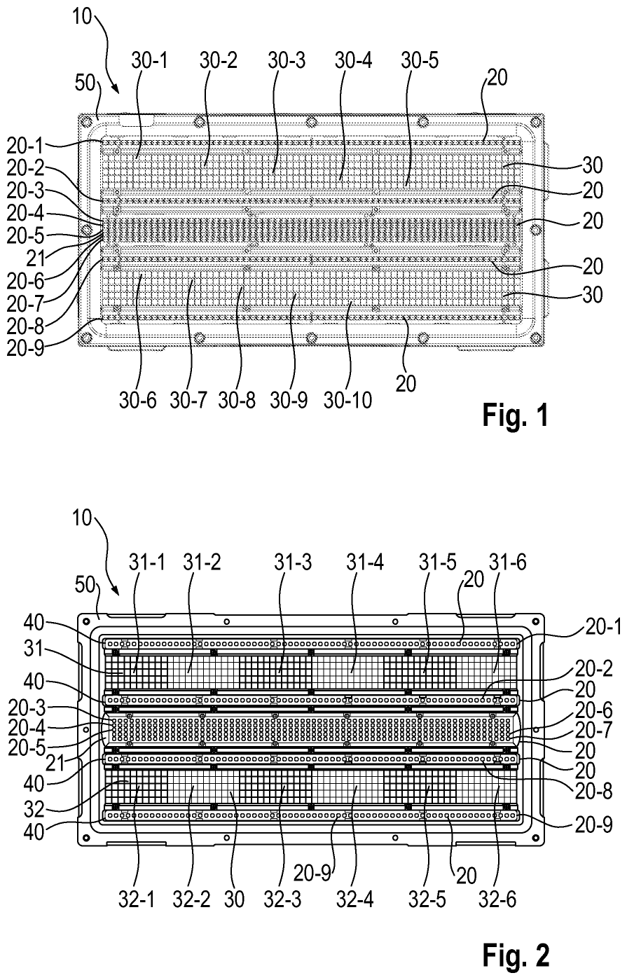

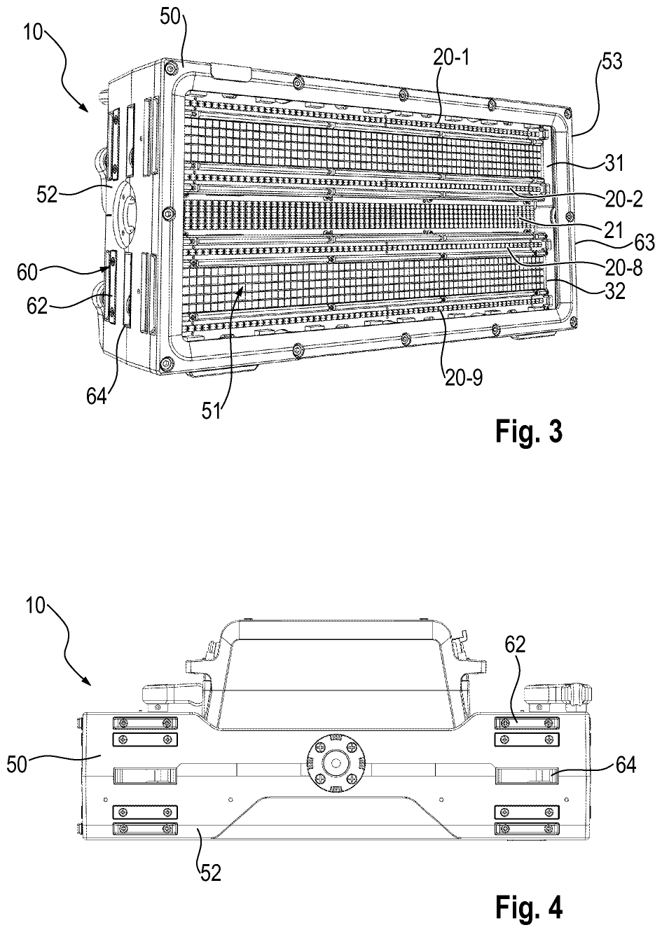

FIGS. 1 and 2 show a front view, FIG. 3 shows a perspective view and FIG. 4 shows a top view of an embodiment of a lighting device 10. The lighting device 10 has a substantially cuboid housing 50, which has a substantially rectangular surface 51, on which a plurality of lighting elements 20, 30 is arranged. 10

The lighting elements 20, 30 are formed by LEDs (light-emitting diodes) and can all be arranged on a single, common circuit board, or on several separate circuit boards (not shown).

As can best be seen from FIGS. 3 and 4, the side surfaces of the housing 50 are formed as connecting surfaces 52, 52. In the embodiment shown, all four side surfaces of the cuboid housing 50 are formed as connecting surfaces 52, 52, i.e. comprise connecting members 62, 63 of a connecting device 60, with which a correspondingly formed lighting device 10 can be connected to an identically formed lighting device 10 or a lighting device 10 which is formed correspondingly as regards the connecting surfaces 52, 53 and connecting members 62, 63, and, thus, a set 100 of lighting devices can be provided. The connecting mechanism 60 is described in detail in DE 10 2022 117 390.

In particular, the connecting mechanism 60 comprises hook elements which are extendable and retractable into grooves or openings, respectively, in the housing 50 on a first connecting surface 52 of a first lighting device 10, and which form a first connecting member 62. These hook elements can be extended from the grooves or openings, respectively, upon connecting to a further lighting device, and can be connected to locking elements, e.g. pins, which form the second connecting elements at the connecting surface 53 of the further lighting device 10. Further, the first and/or second connecting surface 52, 53 can be provided with a positioning mechanism 64, with which alignment of the first lighting device 10 to a further lighting device 10 is facilitated. For example, the positioning mechanism 64 can be formed by means of a set of grooves and complementary projections on the two connecting surfaces 52, 53, and additionally or alternatively, magnet members can be provided which attract each other.

If such connecting surfaces 52, 53 with connecting members are provided, these can also be used for arranging handle elements or grip elements (not shown) or hanging elements at the lighting device 10.

As can best be seen from FIGS. 1 and 2, the lighting elements 203020, 30 of the lighting device 10 are arranged in rows 20-1 to 20-9 and 30-1 to 30-10, respectively, which are parallel to the longitudinal edge of the lighting device 10. In particular, nine rows 20-1 to 20-9 of first lighting elements 20 are provided and ten rows 30-1 to 30-10 of second lighting elements 30 are provided. Each row comprises, for example, 68 lighting elements 20, 30 formed as LEDs, wherein the first lighting elements 20 are formed as CW (cold-white) LEDs and the second lighting elements 30 are formed as RGB LEDs.

The rows 20-1 to 20-9 or 30-1 to 30-10 are arranged symmetrically in the direction perpendicular to the direction of a row on the corresponding surface 51 of the housing. In particular, according to the shown embodiment, the row 20-5 of first lighting elements 20 corresponds to the symmetry axis of the arrangement.

Of the nine rows of first lighting elements 20, five rows 20-3, 20-4, 20-5, 20-6 and 20-7 of first lighting elements are arranged centrally in the direction perpendicular to rows 20-1 to 20-9 and directly adjacent to each other, i.e. with a distance between two adjacent rows 20-3 to 20-7 substantially equal to the distance between two adjacent lighting elements 20 of a row. These rows 20-3 to 20-7 form a group 21 of first lighting elements 20. In the illustrated embodiment, this group 21 of first lighting elements 20 is formed on a common carrier and can only be controlled together. I.e. this group 21 of first lighting elements 20 is formed as a unit and is not controllable as individual rows. Alternatively, several, e.g. five, in principle separately from each other, but also together, controllable rows of first lighting elements could be accordingly arranged as a group and closely spaced.

Four rows 20-1, 20-2, 20-8, 20-9 of first lighting elements 20 are arranged as individual rows, i.e. on both sides their distance to an adjacent row of first lighting elements 20 is significantly greater than the distance between two lighting elements 20 of a row and/or they are adjacent to rows of second lighting elements 30 and/or they are positioned as at the edge of the overall arrangement. For example, rows 20-1 and 20-9 are positioned at the edge and are each adjacent to rows 30-1 and 30-10 of second lighting elements, respectively, on their other side. Rows 20-2 and 20-8 of first lighting elements are adjacent to rows 30-5 and 30-6 of second lighting elements, respectively, on one side and are significantly spaced from rows 20-3 and 20-7 of first lighting elements, respectively, on the other side.

The second lighting elements 30 are arranged in two groups 31, 32 of second lighting elements each having five rows 30-1 to 30-5 and 30-6 to 30-10, i.e., adjacent rows of second lighting elements are the same distance apart as the lighting elements 30 of the row are from each other.

Overall, as viewed from an edge, rows 20-1 to 20-9 and 30-1 to 30-10 of lighting elements 20, 30 are arranged as follows: a single row 20-1 of first lighting elements, a group 31 of five rows 30-1 to 30-5 of second lighting elements, a single row 20-2 of first lighting elements, the central group 21 of first lighting elements comprising five rows 20-3 to 20-7 of first lighting elements 20 which can only be controlled together, a single row 20-8 of first lighting elements, a group 32 of five rows 30-6 to 30-10 of second lighting elements, and a single row 20-9 of first lighting elements. In each case, the spacing of the single rows 20-1 and 20-2 of first lighting elements, the spacing of the single rows 20-2 and 20-8 of first lighting elements, and the spacing of the single rows 20-8 and 20-9 of first lighting elements are identically selected. The distance of the rows 20-1 and 20-9 of first lighting elements from the edge of the lighting device 10 is half the distance of the individual rows 20-2 and 20-8 of first lighting elements, for example. This serves to ensure that when two lighting devices 10 are combined, the distance from an outer row 20-1 of one lighting device 10 to the outer row 20-9 of the other lighting device 10 is the same as, for example, the distance between the individual rows 20-2 and 20-8 of first lighting elements of a single lighting device 10, and thus multiple lighting devices 10 can be seamlessly combined even in the direction perpendicular to the direction of the rows of first lighting elements.

As shown in FIG. 2, the individual rows 20-1, 20-2, 20-8, 220-9 of first lighting elements and the central group 21 of rows 20-3 to 20-7 of first lighting elements are each covered with an elliptical lens 40, 45 to imitate the traditional appearance of Xenon tubes.

FIG. 2 also schematically shows that the groups 31, 32 of second lighting elements are each divided into six segments 31-1 to 31-6 and 32-1 to 32-6, which can be individually controlled by a controller (not shown). Correspondingly (not shown), the individual rows 20-1, 20-2, 20-8 and 20-9 of first lighting elements are each divided into twelve segments along their longitudinal direction, each segment also being individually controllable. The central group 21 of first lighting elements 20 with rows 20-3 to 20-7 is not subdivided into individual segments. This means that this central group can only be controlled together along its longitudinal direction and at the same time can only be controlled as a common block, i.e. over all five rows.

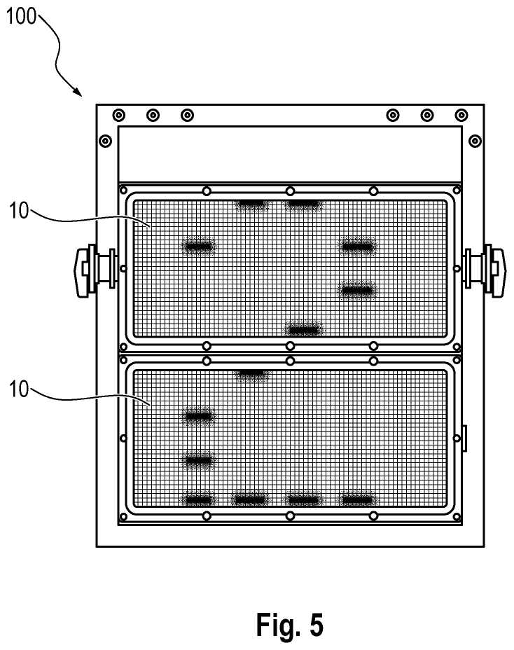

FIGS. 5 to 7 respectively show lighting configurations that can be realized with a set 100 of two lighting devices 10 of the type described, which are interconnected.

FIG. 5 shows a configuration in which the number “2” is modelled by driving and illuminating individual segments of rows 20-1, 20-2, 20-8, and 20-9 of the two lighting devices 10, i.e., segments of each of the four individual rows 20-1, 20-2, 20-8, and 20-9 of first lighting elements.

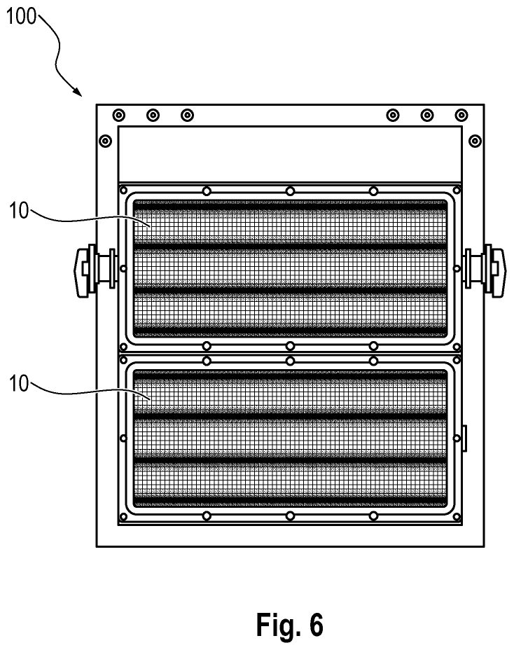

FIG. 6 shows a configuration in which all segments of the rows 20-1, 20-2, 20-8 and 20-9 of the two lighting devices 10, i.e. all segments of the four individual rows 20-1, 20-2, 20-8 and 20-9 of first lighting elements, are controlled and illuminated to produce a continuous line pattern even across several lighting devices 10.

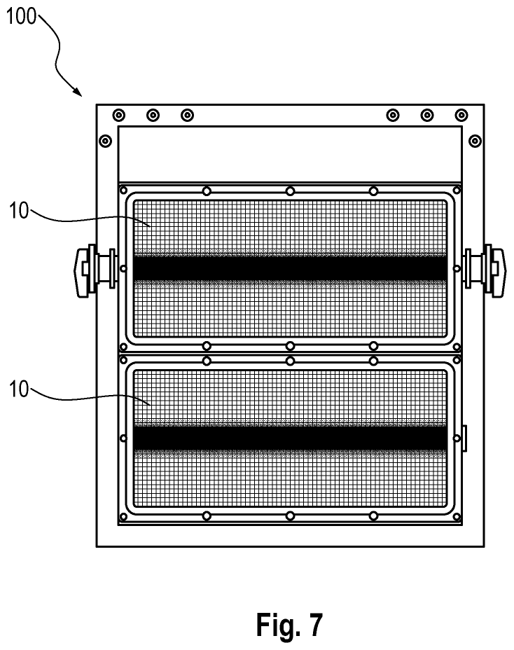

Finally, FIG. 7 shows a configuration in which, by controlling and lighting the group 21 of first lighting elements with the rows 20-3 to 20-7 of the two lighting devices 10, wherein the respective groups 21 of the two lighting devices 10 according to the shown embodiment can each be controlled exclusively together and not segment by segment, a continuous stroke pattern of two stroboscopic light flashes is realized overall, even across several lighting devices 10.

Corresponding patterns can also be achieved by means of the rows of second lighting elements 30-1 to 30-10.

The invention is, thus, based on the idea of providing a highly versatile lighting device which can be used in a variety of ways, which allows on the one hand stroboscopic effects to be achieved as well as white and colored light patterns to be provided. Due to the equal distance of the individual LED lines to each other, continuous effects can be displayed over several devices.

In this way, the devices merge into a big picture in both horizontal and vertical orientation.

It is explicitly mentioned that all features described in the description and/or the claims are intended to be separately and individually disclosed as regards original disclosure and/or a possible limitation of the invention, independent of the feature combination in the embodiments and/or the claims. It is stated, that all indications of ranges or indications of groups or entities also include and disclose any possible intermediate value or part of the group as regards original disclosure and/or a possible limitation of the invention, in particular including for limits of a range.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A lighting device comprising a plurality of first lighting elements adapted to emit light in a fixed first light spectrum and a plurality of second lighting elements adapted to emit light in a variable light spectrum, wherein the first lighting elements and the second lighting elements are each arranged in at least two rows of first lighting elements and at least two rows of second lighting elements, wherein at least a part of the rows of first lighting elements is arranged as a single row.

2. The lighting device according to claim 1, wherein the fixed first light spectrum is white, preferably cold-white.

3. The lighting device according to claim 1, wherein the variable light spectrum is an RGB light spectrum.

4. The lighting device according to claim 1, wherein the lighting elements are LEDs.

5. The lighting device according to claim 1, wherein the rows of first lighting elements arranged as a single row are each covered with an elliptical lens.

6. The lighting device according to claim 1, wherein a plurality of single rows of first lighting elements are provided.

7. The lighting device according to claim 1, wherein at least three rows of first lighting elements are provided, and a part of the rows of first lighting elements form a group of first lighting elements comprising at least two directly adjacent rows of first lighting elements.

8. The lighting device according to claim 7, wherein the group of rows of first lighting elements is arranged in a central area of the lighting device, in a direction perpendicular to the row.

9. The lighting device according to claim 6, wherein the rows of first lighting elements which are arranged as a group, are covered with an elliptical lens.

10. The lighting device according to claim 1, wherein the rows of first lighting elements are grouped into a plurality of separately controllable sections in the longitudinal direction of the rows.

11. The lighting device according to claim 1, wherein at least a part of the rows of second lighting elements is grouped into a group of second lighting elements comprising at least two directly adjacent rows of second lighting elements.

12. The lighting device according to claim 11, wherein the lighting elements of the group of second lighting elements are grouped into a plurality of separately controllable sections in the longitudinal direction of the rows.

13. The lighting device according to claim 1, further comprising a controller for controlling the lighting elements.

14. The lighting device according to claim 1, further comprising a substantially cuboid housing, wherein the lighting elements are arranged on a substantially two dimensional surface of the cuboid housing.

15. A set of a plurality of lighting devices according to claim 1, comprising a first lighting device with a first connecting surface and a second lighting component with a second connecting surface, wherein a first connecting element of a connecting mechanism is provided at the first connecting surface of the first lighting device and a second connecting element of a connecting mechanism is provided at the second connecting surface of the second lighting device, which is complementary to the first connecting element, so that the first lighting device can be detachably connected to the second lighting device by detachably connecting the first connecting element to the second connecting element.
